(19) United States
(12) Patent Application Publication
(10) Pub. No.: US 2023/0128211 A1
(43) Pub. Date: Apr. 27, 2023

(54) HYBRID COOKING APPLIANCE WITH MULTIPLE HEATING FEATURES

(71) Applicants: Xuanjun LI, Wilmington, DE (US); Haier US Appliance Solutions, Inc., Wilmington, DE (US)

(72) Inventors: Dong Soo Shin, Seoul (KR); Taehoon Lim, Seoul (KR); Jaebong Lee, Seoul (KR); Xuanjun Li, Shanghai (CN)

(21) Appl. No.: 16/936,841

(22) PCT Filed: May 18, 2020
(86) PCT No.: PCT/CN2020/090804

§ 371 Date: Jul. 23, 2020

(51) Int. Cl. H05B 6/12; H05B 3/06; H05B 11/00; H05B 6/44

(52) U.S. Cl. CPC H05B 6/129; H05B 3/06; H05B 11/00; H05B 6/44

(57) ABSTRACT

A cooking appliance, as provided herein, may include a cabinet, an induction heating coil, an electric heat-radiation element, and a vertical lift or secondary heating element. The cabinet may define a cooking chamber. The induction heating coil may be mounted within the cabinet below the cooking chamber to direct a magnetic field thereto. The electric heat-radiation element may be mounted within the cabinet above the induction heating coil. The vertical lift may support the electric heat-radiation element within the cooking chamber to adjust a vertical height of the electric heat-radiation element relative to the induction heating coil. The secondary electric heating element may be mounted within the cabinet below the cooking chamber and horizontally spaced apart from the induction heating coil to receive a steam pot.

### CROSS REFERENCE TO RELATED APPLICATIONS

The present application is the National Stage Entry of and claims the benefit of priority under 35 U.S.C. § 371 to PCT Application Serial No. PCT/CN2020/09084 filed May 18, 2020 and entitled HYBRID COOKING APPLIANCE WITH MULTIPLE HEATING FEATURES, which is hereby incorporated by reference in its entirety.

### FIELD OF THE INVENTION

The present subject matter relates generally to cooking appliances, and more particularly to cooking appliances having features for different types of heating in a common chamber.

### BACKGROUND OF THE INVENTION

In recent years, countertop cooking appliances have become increasingly popular given, for instance, their ability to easily cook relatively small amounts of food that would be difficult or inefficient to cook in a conventional baking oven. Some such cooking appliances rely on induction cooking, for example. Generally, for induction cooking, an induction coil produces a high frequency magnetic field, which can cause eddy currents to flow through a cooking vessel made of steel or stainless steel, and thereby heats the foods by the Joule heat produced in the cooking vessel. Other cooking appliances rely on electric heating elements, such as resistive or halogen heating elements, to generate heat directly within the cooking chamber. Still other cooking appliances rely on convective heat generation (e.g., with steam), which may help certain foods retain moisture.

In spite of the variety of existing countertop cooking appliances, challenges still exist. For instance, existing cooking appliances generally generate significant amounts of heat throughout an entire cooking chamber of the cooking appliance. For certain foods, this can be highly inefficient. Additionally or alternatively, such cooking appliances may require significant insulation to retain heat within the cooking chamber (e.g., for efficiency or safety). This, however, will often add to the expense of the system. In the case of appliances within steam-generation systems, such systems are often very complex and difficult to clean. Thus, they may further add to costs and safety concerns of any such appliance.

In turn, a cooking appliance addressing one or more of the above issues would be useful. Specifically, it may be advantageous to provide a cooking appliance capable of efficiently heating a variety of food items (e.g., without requiring significant insulation). Additionally or alternatively, it may be advantageous to provide a cooking appliance with one or more features for easily generating steam and permit cleaning of the same.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include a cabinet, an induction heating coil, an electric heat-radiation element, and a vertical lift. The cabinet may define a cooking chamber. The induction heating coil may be mounted within the cabinet below the cooking chamber to direct a magnetic field thereto. The electric heat-radiation element may be mounted within the cabinet above the induction heating coil. The vertical lift may support the electric heat-radiation element within the cooking chamber to adjust a vertical height of the electric heat-radiation element relative to the induction heating coil.

In another exemplary aspect of the present disclosure, a cooking appliance is provided. The cooking appliance may include a cabinet, an induction heating coil, an electric heat-radiation element, the cabinet may define a cooking chamber. The induction heating coil may be mounted within the cabinet below the cooking chamber to direct a magnetic field thereto. The electric heat-radiation element may be mounted within the cabinet above the induction heating coil. The secondary electric heating element may be mounted within the cabinet below the cooking chamber and horizontally spaced apart from the induction heating coil. The steam pot may be positioned on top of the secondary electric heating element to receive heat therefrom. The steam pot may define an internal volume to receive liquid water and a steam outlet to direct water vapor from the internal volume.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a side elevation view of the exemplary cooking appliance of FIG. 1.

FIG. 3 provides a perspective view of the exemplary cooking appliance of FIG. 1, wherein various elements, such as a front door, have been removed for clarity.

FIG. 4 provides a lower perspective view of the exemplary cooking appliance of FIG. 1, wherein various elements, such as the front door and an outer shell of a cabinet, have been removed for clarity.

FIG. 5 provides a perspective view of a lift assembly of the exemplary cooking appliance of FIG. 4.

FIG. 6 provides a top perspective view of a cooking appliance according to exemplary embodiments of the present disclosure, wherein a rear door has been removed for clarity.

FIG. 7 provides a top perspective view of the exemplary cooking appliance of FIG. 6, wherein a chamber baseplate has been separated from a cooking chamber for clarity.

FIG. 8 provides a bottom view of the exemplary cooking appliance of FIG. 6.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

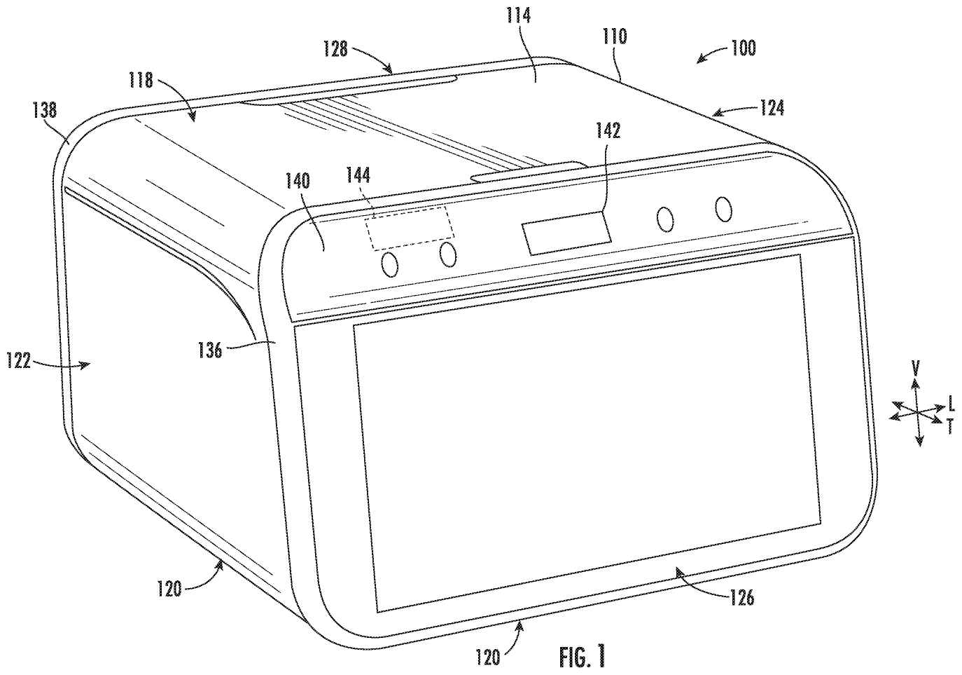

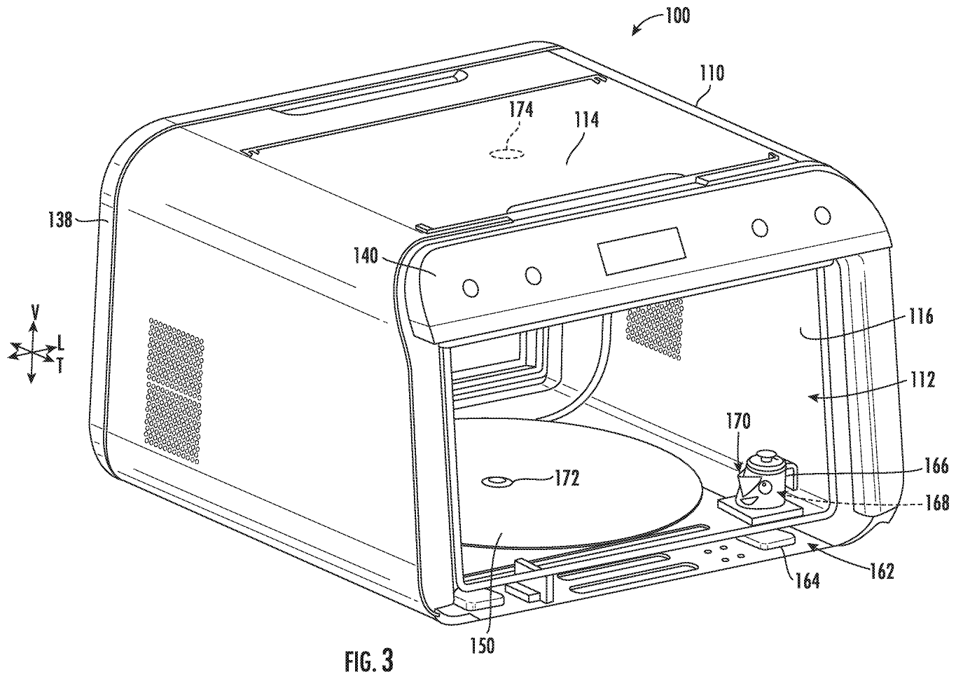

Turning now to the figures, FIGS. 1 through 4, provide various views of a cooking appliance 100 according to exemplary embodiments of the present disclosure. Generally, cooking appliance 100 defines a vertical direction V, a lateral direction L, and a transverse direction T, for example, at a cabinet 110.

As shown, cooking appliance 100 includes a plurality of outer walls (e.g., outer casing 114 of cabinet 110). When assembled, cooking appliance 100 generally extends along the vertical direction V between a top end 118 and a bottom end 120; along the lateral direction L between a first side end 122 and a second side end 124; and along the transverse direction T between a front end 126 and a rear end 128.

Within outer casing 114, an inner liner 116 of cabinet 110 defines a cooking chamber 112 for receipt of food items for cooking. Moreover, cabinet 110 (including outer casing 114 and inner liner 116) defines one or more chamber openings through which cooking chamber 112 can be accessed. In some embodiments, this includes a front opening 132 in fluid communication with cooking chamber 112 to permit access to cooking chamber 112. Specifically, front opening 132 may be defined at front end 126. In optional embodiments, a second opening (e.g., rear opening 134) is provided. As shown, a rear opening 134 may be defined at rear end 128, spaced apart from front opening 132 along the transverse direction T. Optionally, rear opening 134 may be similar is shape and dimensions to front opening 132 or, alternatively, defined according to a different shape or dimensions from front opening 132.

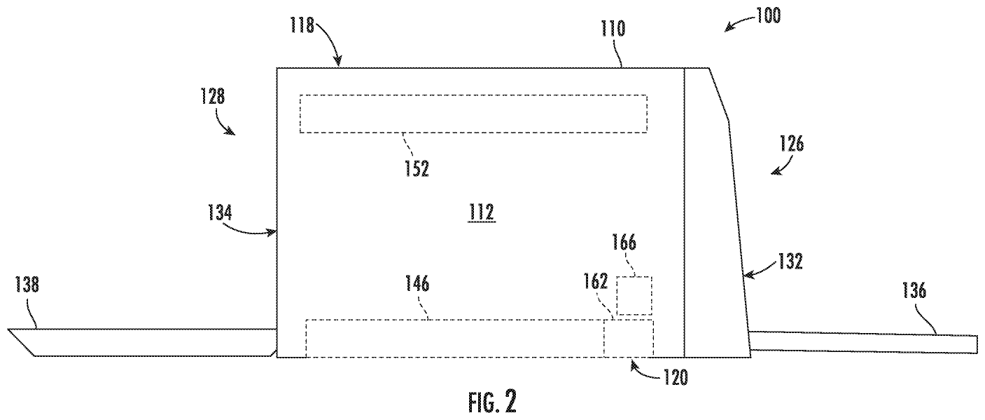

As shown, one or more doors may be provided to selectively cover each of the chamber openings (e.g., to close cooking chamber 112 or otherwise restrict access to cooking chamber 112 through the corresponding chamber opening). For instance, a front door 136 may be movably (e.g., pivotally, slidably, etc.) mounted to cabinet 110 to move between a closed position (FIG. 1) restricting access through front opening 132 and an open position (FIG. 2) permitting access through front opening 132 such that a user can insert/remove food articles into/from cooking chamber 112. In the illustrated embodiments, front door 136 is pivotally mounted at a bottom end 120 of cabinet 110 to rotate about a front horizontal axis. Additionally or alternatively, a rear door 138 may be movably (e.g., pivotally, slidably, etc.) mounted to cabinet 110 to move between a closed position (FIG. 1) restricting access through rear opening 134 and an open position (FIG. 2) permitting access through front opening 134 such that a user can insert/remove food articles into/from cooking chamber 112. In the illustrated embodiments, rear door 138 is pivotally mounted at a bottom end 120 of cabinet 110 to rotate about a rear horizontal axis (e.g., independently of front door 136).

In certain embodiments, cooking appliance 100 includes a control panel 140 mounted on or as part of cabinet 110. Generally, control panel 140 includes a display device 142 for presenting various information to a user. Control panel 140 may also include one or more input devices (e.g., tactile buttons, knobs, touch screens, etc.). Selections may be made by engaging (e.g., pressing, rotating, etc.) the input devices. For example, many meal cook cycles and other cooking algorithms can be preprogrammed in or loaded onto a memory device of a controller 144 of cooking appliance 100 for many different food items types (e.g., pizza, fried chicken, French fries, potatoes, steak, etc.), including simultaneous preparation of a group of food items of different food types comprising an entire meal. Instructions or selections may be displayed on display device 142. In optional embodiments, display device 142 can be used as an input device. For instance, display device 142 may be a touchscreen device, as is understood.

A lower heater module 146 is generally provided within cabinet 110 (e.g., below at least a portion of cooking chamber 112). In some embodiments, lower heater module 146 includes an induction heating coils 148 in communication (e.g., transmissive communication) with cooking chamber 112 to direct a magnetic field thereto. In particular, induction heating coils 148 may be mounted beneath a bottom wall or chamber baseplate 150 of inner liner 116. In some embodiments, a hole or opening is defined through the bottom wall of inner liner 116 (e.g., defining a diameter greater than or equal to a horizontal diameter of induction heating coils 148). Above induction heating coils 148 (e.g., and within cooking chamber 112) a tray or platter may be provided on which an article (e.g., food item) may be supported. For induction cooking, any such article be provided with an induction cooking vessel, as is understood.

Separate from or in addition to lower heater module 146, an upper heater module 152 is generally provided within cabinet 110 (e.g., above lower heater module 146 and at least a portion of cooking chamber 112). In some embodiments, upper heater module 152 includes one or more electric heat-radiation elements 154 to generate and radiate heat to the air within cooking chamber 112. For instance, upper heater module 152 can include a resistive heating element (e.g., sheathed resistive heater) or halogen heating element (e.g., halogen cooking lamp).

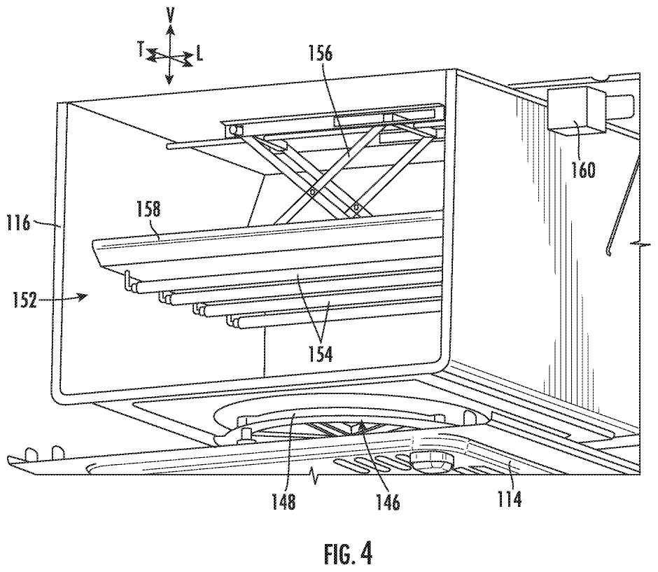

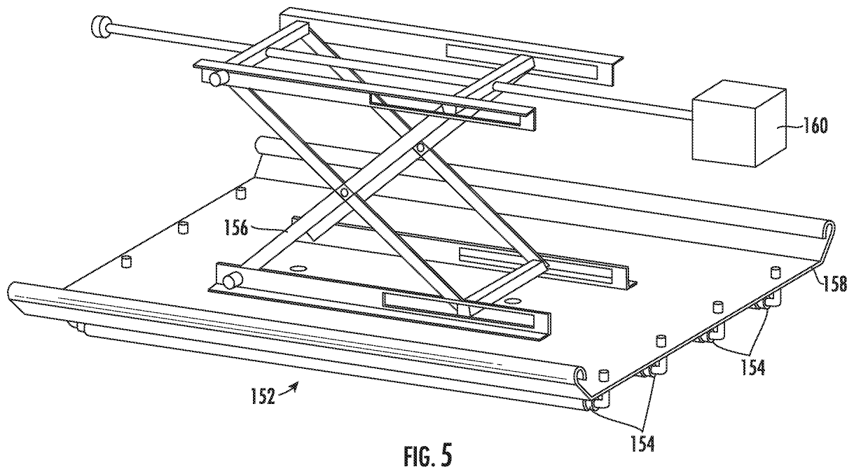

Turning especially to FIGS. 4 and 5, a vertical lift 156 mounted within cabinet 110 (e.g., above or at a top portion of cooking chamber 112) is illustrated. In some embodiments, a vertical lift 156 is provided to support upper heater module 152. For instance, vertical lift 156 may be mounted on or within inner liner 116. One or more of electric heat-radiation elements 154 are joined to a mounting plate 158 of vertical lift 156. Generally, vertical lift 156 supports upper heater module 152, including one or more electric heat-radiation elements 154, to move up and down along the vertical direction V. Thus, vertical lift 156 may adjust the vertical height of upper heater module 152 relative to lower heater module 146 or the bottom end 120 of cooking chamber 112 generally. In particular, vertical lift 156 may move along the vertical direction V between a raised position that is distal to the induction heating coils 148 (i.e., proximal to top end 118) and an extended position that is proximal to induction heating coils 148 (i.e., distal to top end 118).

In certain embodiments, an electric motor 160 is mounted within cabinet 110 and attached in mechanical communication with vertical lift 156. Specifically, electric motor 160 may be mounted above cooking chamber 112 to actuate vertical lift 156 (e.g., automatically or as directed by a user via control panel 140). For example, electric motor 160 may rotate one or more intermediate gears to motivate raise or extend vertical lift 156 according to a desired or suitable distance between electric heat-radiation element(s) 154 and an article received within cooking chamber 112.

In the exemplary embodiments of FIGS. 4 and 5, vertical lift 156 is generally provided as a scissor jack. However, it is understood that any other suitable actuating assembly (e.g., linear actuator, pulley system, rack and pinion, etc.) may be provided to move electric heat-radiation element(s) 154 or mounting plate 158 along the vertical direction V.

Advantageously, a cooking appliance 100, as provided herein, may be able to vary the concentration of heat or temperature on a variety of articles (e.g., food items) without requiring heating the entire cooking chamber 112 or requiring significant amounts/volumes of insulation between outer casing 114 and inner liner 116.

Returning generally to FIGS. 1 through 4, certain embodiments of cooking appliance 100 include a steam heater module 162. As shown, steam heater module 162 may include a secondary electric heating element 164 mounted within cabinet 110 below cooking chamber 112. Moreover, secondary electric heating element 164 is horizontally (e.g., laterally or transversely) spaced apart from induction heating coil(s) 148. Thus, secondary electric heating element 164 is separated from induction heating coils 148 and may be activated independently from lower heater module 146. In particular, secondary electric heating element 164 may be selectively activated to generate heat within a portion of cabinet 110 or cooking chamber 112 apart from induction heating coils 148. As would be understood, secondary electric heating element 164 may include or be provided as any electrically-driven heat generator to supply heat to the region directly above secondary electric heating element 164, such an induction heating element, resistive heating element, or halogen heating element. Optionally, secondary electric heating element 164 may be substantially smaller than induction heating coils 148. For instance, secondary electric heating element 164 may define a horizontal footprint or heating zone having an area less than 20% than the area of the horizontal footprint or heating zone of the induction heating coils 148.

In some embodiments, a steam pot 166 is provided to be selectively positioned on top of secondary electric heating element 164 (e.g., to receive heat therefrom). Generally, steam pot 166 may be a relatively small container to hold water that can be heated and released as water vapor (i.e., steam) within cooking chamber 112. Specifically, steam pot 166 may define an internal volume 168 to receive and hold liquid water, as well as a steam outlet 170 (e.g., above the internal volume 168) to direct or permit water vapor to escape internal volume 168 (and steam pot 166, generally)

Steam pot 166 may include or be formed from any suitable material for being repeatedly heated above the boiling temperature of water (e.g., metal or ceramic). Thus, as secondary electric heating element 164 is activated, the heat generated at secondary electric heating element 164 may be received at steam pot 166, within which liquid water is vaporized and released as water vapor. Optionally, steam pot 166 may be matched in horizontal width or shape to secondary electric heating element 164 such that the horizontal footprint of each is within 10% of each other. Additionally or alternatively, steam pot 166 may be selectively placed on top of secondary electric heating element 164 and subsequently removed from secondary electric heating element 164 (e.g., by a user who is able to pick up and relocate steam pot 166).

Advantageously, steam may be selectively supplied to cooking chamber 112 from steam pot 166 as desired, and when no steam is desired or cleaning of steam pot 166 would be appropriate, a user may easily remove steam pot 166 from cabinet 110 (e.g., to refill internal volume 168 or clean steam pot 166).

As shown, cooking appliance 100 may include a controller 144. Controller 144 of cooking appliance 100 can include one or more processor(s) and one or more memory device(s). The processor(s) of controller 144 can be any suitable processing device, such as a microprocessor, microcontroller, integrated circuit, or other suitable processing device. The memory device(s) of controller 144 can include any suitable computing system or media, including, but not limited to, non-transitory computer-readable media, RAM, ROM, hard drives, flash drives, or other memory devices. The memory device(s) of controller 144 can store information accessible by the processor(s) of controller 144 including instructions that can be executed by the processor(s) of controller 144 in order to execute various cooking operations or cycles (e.g., a meal cook cycle). Controller 144 is in operative communication (e.g., electrical communication or wireless communication) with various operational components of cooking appliance 100, such as components of lower heater module 146, upper heater module 152, steam heater module 162, or control panel 140. Input/output (“I/O”) signals may be routed between controller 144 and control panel 140 as well as other operational components of cooking appliance 100. Controller 144 can execute and control cooking appliance 100 in various cooking operations or cycles, such as precision cooking, which includes meal cook, warming, induction, or convection/bake modes.

Generally, controller 144 can be positioned in any suitable location throughout cooking appliance 100. For example, controller 144 may be located proximate to control panel 140 toward front end 126 of cooking appliance 100.

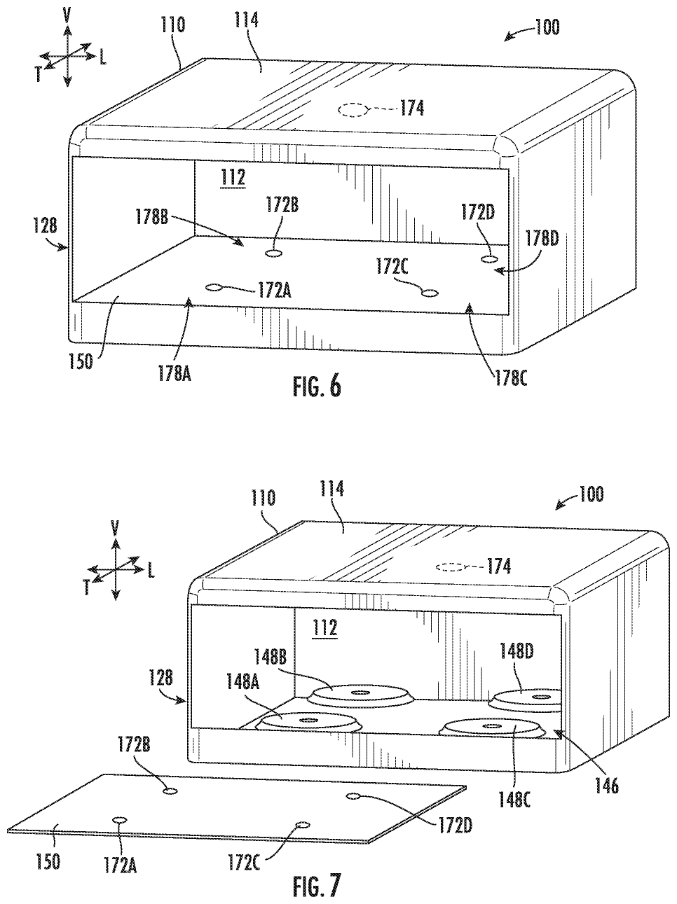

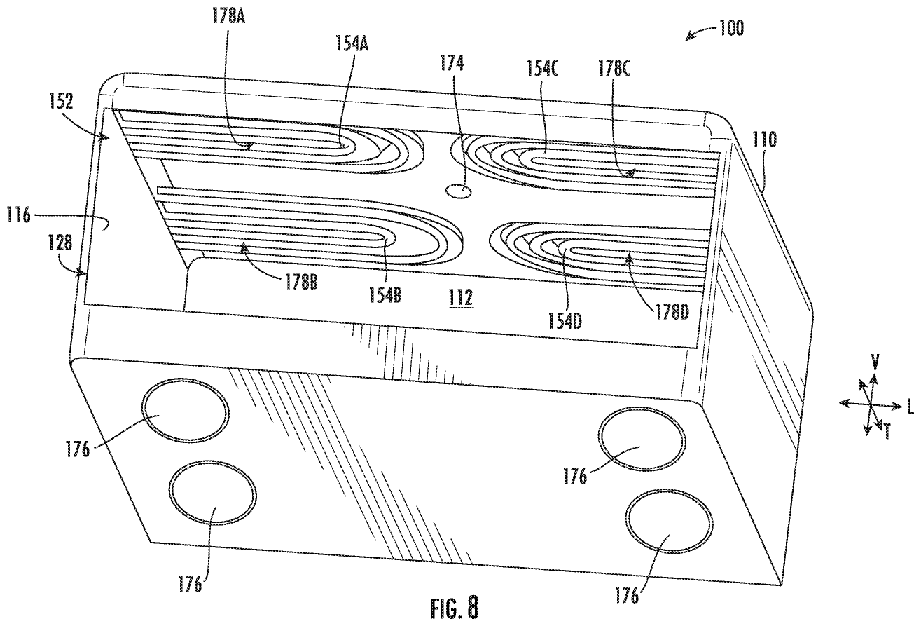

Turning now to FIGS. 6 through 8, various views are provided of cooking appliance 100 according to additional or alternative embodiments. As shown, one or more conductive temperature sensors 172 may be mounted to cabinet 110 (e.g., in operative communication with controller 144—FIG. 1) to detect a temperature within cooking chamber 112, such as an article received within cooking chamber 112. Generally, each conductive temperature sensor 172 may include or be provided as a thermistor, thermocouple, or any other suitable sensor configured to measure temperature (e.g., as a discrete value). In some embodiments, a conductive temperature sensor 172 is mounted to a chamber baseplate 150 and is configured to detect a temperature of an article positioned on or on top of conductive temperature sensor 172.

In additional or alternative embodiments, an infrared (e.g., proximity) sensor 174 is mounted to cabinet 110 (e.g., in operative communication with controller 144—FIG. 1) to detect a distance between infrared sensor 174 and an article (e.g., food item) received within cooking chamber 112 (e.g., on the chamber baseplate 150). Specifically, infrared sensor 174 may be configured to measure the direct distance (e.g., vertical distance) between itself and an object within its predetermined line of sight, as would be understood. Thus, as articles are placed within cooking chamber 112, infrared sensor 174 may effectively detect or measure one or more size dimensions of the article. In some embodiments, infrared sensor 174 is directed toward cooking chamber 112, such as from an upper portion thereof. For instance, infrared sensor 174 may be mounted above the chamber baseplate 150 or lower heater module 146, generally. Optionally, infrared sensor 174 may be mounted to a top wall of inner liner 116. Additionally or alternatively, infrared sensor 174 may be mounted to vertical lift 156 (e.g., on mounting plate 158—FIG. 4) to move therewith. In some such embodiments, controller 144 may advantageously adjust or limit the vertical height of upper heater module 152 according to the height measured at infrared sensor 174.

In optional embodiments, cooking appliance 100 includes one or more weight or mass sensors 176 (e.g., force or pressure sensors) mounted to cabinet 110. Generally, the mass sensor(s) 176 can be configured to measure the weight of the articles (e.g., food items) within cooking chamber 112, such as during cooking operations. In the illustrated embodiments, a discrete mass sensor 176 is arranged in each of, for example, four feet supporting cabinet 110. In turn, cooking appliance 100 may be configured to automatically determine the mass distribution within the cooking chamber 112 based on the measured mass distribution across the feet. Nonetheless, alternative embodiments may include more (e.g., five or more) or less mass sensors 176, such as a single mass sensor 176 within a single foot. Additionally or alternatively, mass sensors may be mounted at another suitable location on cabinet 110 (e.g., below cooking chamber 112).

In additional or alternative embodiments, multiple discrete cooking regions 178A, 178B, 178C, 178D are provided within cooking chamber 112. Generally, each cooking region includes a corresponding induction heating coil. Thus, lower heater module 146 may include multiple induction heating coils horizontally spaced apart from each other (e.g., such that the footprint or heating zone of each induction heating coil does not overlap with that of the other induction heating coils in a horizontal plane). For instance, lower heater module 146 may include a first induction heating coil 148A and a second induction heating coil 148B horizontally spaced apart from the first induction heating coil 148A. Thus, the second induction heating coil 148B may be mounted at a different, non-overlapping portion of cabinet 110 from the first induction heating coil 148A. The first and second induction heating coils 148A, 148B may be configured to activate independently from each other (e.g., as directed by controller 144) and, thus, may direct separate electric fields to different portions of the cooking chamber 112 (e.g., at different times). In the illustrated embodiments, a third induction heating coil 148C and a fourth induction heating coil 148D are further provided such that a discrete induction heater coil for a corresponding cooking region is provided proximal to each corner of cabinet 110. Nonetheless, it is understood that any suitable number or location layout may be provided for induction heating coils or cooking regions in accordance with the present disclosure.

Optionally, a discrete conductive temperature sensor may be provided at each discrete cooking region. As an example, a first conductive temperature sensor 172A may be mounted within the first cooking region 178A above the first induction heating coil 148A to detect a temperature of an article within the first cooking region 178A. When assembled, the first conductive temperature sensor 172A may be, for instance, mounted to the chamber baseplate 150 in vertical alignment with the first induction heating coil 148A. Thus, the first conductive temperature sensor 172A may be located directly above the first induction heating coil 148A or otherwise occupy an area that overlaps with the footprint or heating zone of the first induction heating coil 148A (e.g., when viewed along the vertical direction V).

As an additional or alternative example, a second conductive temperature sensor 172B may be mounted within the second cooking region 178B above the second induction heating coil 148B to detect a temperature of an article within the second cooking region 178B. When assembled, the second conductive temperature sensor 172B may be, for instance, mounted to the chamber baseplate 150 in vertical alignment with the second induction heating coil 148B. Thus, the second conductive temperature sensor 172B may be located directly above the second induction heating coil 148B or otherwise occupy an area that overlaps with the footprint or heating zone of the second induction heating coil 148B (e.g., when viewed along the vertical direction V).

As another additional or alternative example, a third conductive temperature sensor 172C may be mounted within the third cooking region 178C above the third induction heating coil 148C to detect a temperature of an article within the third cooking region 178C. When assembled, the third conductive temperature sensor 172C may be, for instance, mounted to the chamber baseplate 150 in vertical alignment with the third induction heating coil 148C. Thus, the third conductive temperature sensor 172C may be located directly above the third induction heating coil 148C or otherwise occupy an area that overlaps with the footprint or heating zone of the third induction heating coil 148C (e.g., when viewed along the vertical direction V).

As yet another additional or alternative example, a fourth conductive temperature sensor 172D may be mounted within the fourth cooking region 178D above the fourth induction heating coil 148D to detect a temperature of an article within the fourth cooking region 178D. When assembled, the fourth conductive temperature sensor 172D may be, for instance, mounted to the chamber baseplate 150 in vertical alignment with the fourth induction heating coil 148D. Thus, the fourth conductive temperature sensor 172D may be located directly above the fourth induction heating coil 148D or otherwise occupy an area that overlaps with the footprint or heating zone of the fourth induction heating coil 148D (e.g., when viewed along the vertical direction V).

In some embodiments, upper heater module 152 includes a discrete electric heat-radiation element (e.g., a resistive heating element or halogen heating element) corresponding to one or more of the discrete cooking regions 178A, 178B, 178C, 178D. Thus, upper heater module 152 may include multiple electric heat-radiation elements horizontally spaced apart from each other (e.g., such that the footprint or heating zone of each electric heat-radiation element does not overlap with that of the other electric heat-radiation elements in a horizontal plane).

As an example, a first electric heat-radiation element 154A may be mounted within the first cooking region 178A above the first induction heating coil 148A to radiate heat between first induction heating coil 148A and first electric heat-radiation element 154A. When assembled, the first electric heat-radiation element 154A may be, for instance, mounted to the inner liner 116 or vertical lift 156 (FIG. 4) in vertical alignment with the first induction heating coil 148A. Thus, the first electric heat-radiation element 154A be located directly above the first induction heating coil 148A or otherwise occupy an area that overlaps with the footprint or heating zone of the first induction heating coil 148A (e.g., when viewed along the vertical direction V).

As an additional or alternative example, a second electric heat-radiation element 154B may be mounted within the second cooking region 178B above the second induction heating coil 148B to radiate heat between second induction heating coil 148B and second electric heat-radiation element 154B. When assembled, the second electric heat-radiation element 154B may be, for instance, mounted to the inner liner 116 or vertical lift 156 (FIG. 4) in vertical alignment with the second induction heating coil 148B. Thus, the second electric heat-radiation element 154B may be located directly above the second induction heating coil 148B or otherwise occupy an area that overlaps with the footprint or heating zone of the second induction heating coil 148B (e.g., when viewed along the vertical direction V).

As another additional or alternative example, a third electric heat-radiation element 154C may be mounted within the third cooking region 178C above the third induction heating coil 148C to radiate heat between third induction heating coil 148C and third electric heat-radiation element 154C. When assembled, the third electric heat-radiation element 154C may be, for instance, mounted to the inner liner 116 or vertical lift 156 (FIG. 4) in vertical alignment with the third induction heating coil 148C. Thus, the third electric heat-radiation element 154C may be located directly above the third induction heating coil 148C or otherwise occupy an area that overlaps with the footprint or heating zone of the third induction heating coil 148C (e.g., when viewed along the vertical direction V).

As yet another additional or alternative example, a fourth electric heat-radiation element 154D may be mounted within the fourth cooking region 178D above the fourth induction heating coil 148D to radiate heat between third induction heating coil 148C and fourth electric heat-radiation element 154D. When assembled, the fourth electric heat-radiation element 154D may be, for instance, mounted to the inner liner 116 or vertical lift 156 (FIG. 4) in vertical alignment with the fourth induction heating coil 148D. Thus, the fourth electric heat-radiation element 154D may be located directly above the fourth induction heating coil 148D or otherwise occupy an area that overlaps with the footprint or heating zone of the fourth induction heating coil 148D (e.g., when viewed along the vertical direction V).

Optionally, multiple electric heat-radiation elements 154A, 154B, 154C, 154D may be configured to activate independently from each other (e.g., as directed by controller 144) and, thus, may radiate heat to different portions of the cooking chamber 112 (e.g., at different times). Additionally or alternatively, the electric heat-radiation element 154A, 154B, 154C, or 154D of each cooking region 178A, 178B, 178C, or 178D may be configured to activate independently of the induction heating coils 148A, 148B, 148C, or 148D of the corresponding cooking region 178A, 178B, 178C, or 178D.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a cabinet defining a cooking chamber;
an induction heating coil mounted within the cabinet below the cooking chamber to direct a magnetic field thereto;
an electric heat-radiation element mounted within the cabinet above the induction heating coil; and
a vertical lift supporting the electric heat-radiation element within the cooking chamber to adjust a vertical height of the electric heat-radiation element relative to the induction heating coil.

2. The cooking appliance of claim 1, wherein the cabinet further defines a front opening in fluid communication with the cooking chamber to permit access thereto and a rear opening spaced opposite the front opening and in fluid communication with cooking chamber to permit access thereto, wherein the cooking appliance further comprises:
a front door movably mounted to the cabinet to selectively cover the front opening and restrict access to the cooking chamber through the front opening; and
a rear door movably mounted to the cabinet to selectively cover the rear opening and restrict access to the cooking chamber through the rear opening.

3. The cooking appliance of claim 1, further comprising:
an electric motor in mechanical communication with the vertical lift above the cooking chamber to selectively actuate the vertical lift along a vertical direction.

4. The cooking appliance of claim 1, further comprising:
a secondary electric heating element mounted within the cabinet below the cooking chamber and horizontally spaced apart from the induction heating coil; and
a steam pot positioned on top of the secondary electric heating element to receive heat therefrom, the steam pot defining an internal volume to receive liquid water and a steam outlet to direct water vapor from the internal volume.

5. The cooking appliance of claim 1, further comprising:
a chamber baseplate mounted above the induction heating coil and below the electric heat-radiation element; and
a conductive temperature sensor mounted to the chamber baseplate to detect a temperature of an article thereon.

6. The cooking appliance of claim 1, wherein the induction heating coil is a first induction heating coil, wherein the electric heat-radiation element is a first electric heat-radiation element vertically aligned with the first induction heating coil in a first cooking region, and wherein the cooking appliance further comprises:
a second induction heating coil mounted within the cabinet below the cooking chamber to direct a magnetic field thereto, the second induction heating coil being horizontally spaced apart from the first induction heating coil; and
a second electric heat-radiation element mounted within the cabinet above the second induction heating coil and vertically aligned therewith in a second cooking region.

7. The cooking appliance of claim 6, further comprising:
a chamber baseplate mounted above the first and second induction heating coils as well as below the first and second electric heat-radiation elements; and
a first conductive temperature sensor mounted to the chamber baseplate in vertical alignment with the first induction heating coil to detect a temperature of an article within the first cooking region; and
a second conductive temperature sensor mounted to the chamber baseplate in vertical alignment with the second induction heating coil to detect a temperature of an article within the second cooking region.

8. The cooking appliance of claim 1, further comprising:
an infrared sensor directed toward the cooking chamber to detect a distance between the infrared sensor and an article within the cooking chamber.

9. A cooking appliance comprising:
a cabinet defining a cooking chamber;
an induction heating coil mounted within the cabinet below the cooking chamber to direct a magnetic field thereto;
an electric heat-radiation element mounted within the cabinet above the induction heating coil;
a secondary electric heating element mounted within the cabinet below the cooking chamber and horizontally spaced apart from the induction heating coil; and
a steam pot positioned on top of the secondary electric heating element to receive heat therefrom, the steam pot defining an internal volume to receive liquid water and a steam outlet to direct water vapor from the internal volume.

10. The cooking appliance of claim 9, wherein the cabinet further defines a front opening in fluid communication with the cooking chamber to permit access thereto and a rear opening spaced opposite the front opening and in fluid communication with cooking chamber to permit access thereto, wherein the cooking appliance further comprises:
a front door movably mounted to the cabinet to selectively cover the front opening and restrict access to the cooking chamber through the front opening; and
a rear door movably mounted to the cabinet to selectively cover the rear opening and restrict access to the cooking chamber through the rear opening.

11. The cooking appliance of claim 9, further comprising:
a vertical lift supporting the electric heat-radiation element within the cooking chamber to adjust a vertical height of the electric heat-radiation element, the vertical lift being movable along a vertical direction relative to the induction heating coil; and
an electric motor in mechanical communication with the vertical lift above the cooking chamber to selectively actuate the vertical lift along the vertical direction.

12. The cooking appliance of claim 9, further comprising:
a chamber baseplate mounted above the induction heating coil and below the electric heat-radiation element; and
a conductive temperature sensor mounted to the chamber baseplate to detect a temperature of an article thereon.

13. The cooking appliance of claim 9, wherein the induction heating coil is a first induction heating coil, wherein the electric heat-radiation element is a first electric heat-radiation element vertically aligned with the first induction heating coil in a first cooking region, and wherein the cooking appliance further comprises:
a second induction heating coil mounted within the cabinet below the cooking chamber to direct a magnetic field thereto, the second induction heating coil being horizontally spaced apart from the first induction heating coil; and
a second electric heat-radiation element mounted within the cabinet above the second induction heating coil and vertically aligned therewith in a second cooking region.

14. The cooking appliance of claim 13, further comprising:
a chamber baseplate mounted above the first and second induction heating coils as well as below the first and second electric heat-radiation elements; and
a first conductive temperature sensor mounted to the chamber baseplate in vertical alignment with the first induction heating coil to detect a temperature of an article within the first cooking region; and
a second conductive temperature sensor mounted to the chamber baseplate in vertical alignment with the second induction heating coil to detect a temperature of an article within the second cooking region.

15. The cooking appliance of claim 9, further comprising:
an infrared sensor directed toward the cooking chamber to detect a distance between the infrared sensor and an article within the cooking chamber.
